(19) United States
(12) Patent Application Publication
(10) Pub. No.: US 2003/0158880 A1
(43) Pub. Date: Aug. 21, 2003

(54) Booth encoder and partial products circuit

(76) Inventor: Kenneth Y. Ng, Saratoga, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/073,190

(22) Filed: Feb. 13, 2002

(51) Int. Cl. G06F 7/52

(52) U.S. Cl. 708/628

(57) ABSTRACT

A Booth encoder and partial products generator circuit may be provided. The Booth encoder circuit may include a plurality of transistors to receive a plurality of multiplier bits and complements of the plurality of multiplier bits. The Booth encoder circuit may also include a plurality of logic gates (or circuits) coupled to ones of the plurality of transistors to output Booth encoded signals. The partial products generator circuit may include a first multiplexing device having a plurality of first transistors to receive the Booth encoded signals and to provide a first partial products output, and a second multiplexing device having a plurality of second transistors to receive the Booth encoded signals and to provide a second partial products output. The second multiplexing device further to receive multiplexed data from the first multiplexing device when providing the second partial products output.

### FIELD

The present invention relates to multiplier circuits. More particularly, the present invention relates to a Booth encoder and partial products circuit.

### BACKGROUND

Multiplier circuits are found in virtually every computer, cellular telephone, and digital audio/video equipment. In fact, essentially any digital device used to handle speech, stereo, image, graphics, and/or multimedia content may contain one or more multiplier circuits. The multiplier circuits are usually integrated within microprocessor, media co-processor, and digital signal processor chips. These multipliers may be used to perform a wide range of functions such as address generation, discrete cosine transformations (DCT), Fast Fourier Transforms (FFT), multiply-accumulate, etc. As such, multipliers play a critical role in processing audio, graphics, video, and multimedia data.

Multiplier circuits are designed to operate as fast as possible. This is because vast amounts of digital data must be processed within an extremely short amount of time. For example, generating a frame's worth of data for display onto a computer screen or digital camera may entail processing upwards of over a million pixels. Often several multiplication functions must be invoked just to rasterize a single one of these final pixel values. For real-time applications (e.g., flight simulators, speech recognition, video teleconferencing, computer games, streaming audio/video, etc.), the overall system performance may be dramatically dependent upon the speed of its multipliers.

Unfortunately, multiplication is an inherently slow operation. Adding two numbers together may require a single add operation. In contrast, multiplication may require that each of the digits of the multiplicand be multiplied by each digit of the multiplier to arrive at the partial products. The partial products may then be added together to obtain the final solution. For example, 123×456 requires the addition of the three partial products of (123×400)=49200+(123×50)=6150+(123×6)=738 to obtain the final answer of 56088. As applied to binary numbers, multiplying two 32-bit numbers may necessitate that thirty-two partial products be calculated and then thirty-two add operations may be performed to add together all of the partial products to obtain the final solution. Thus, multiplications are relatively time-consuming.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto. The following represents brief descriptions of the drawings in which like reference numerals represent like elements and wherein:

FIG. 1 shows an example of a Booth encoder/selector circuit;

FIG. 2 is a block diagram of a 16×16 bit multiplier circuit;

FIG. 3 is a circuit diagram of a Booth encoder circuit;

FIG. 4 is a circuit diagram of a Booth encoder circuit according to an example embodiment of the present invention;

FIG. 5 is a circuit diagram of a 5:1 multiplexer;

FIG. 6 is a circuit diagram of multiple 5:1 multiplexers;

FIG. 7 is a circuit diagram of one 5:1 multiplexer according to an example arrangement;

FIG. 8 shows a booth recoder circuit according to one arrangement;

FIG. 9 is a circuit diagram of two adjacent multiplexers according to one arrangement; and

FIG. 10 is a circuit diagram of two adjacent multiplexers for a partial products generating circuit according to an example embodiment of the present invention.

### DETAILED DESCRIPTION

In the following detailed description like reference numerals and characters may be used to designate identical, corresponding or similar components in differing figure drawings. Example values may be given, although the present invention is not limited to the same. While signals (or values) may be described as HIGH or LOW, these descriptions of HIGH and LOW are intended to be relative to the discussed arrangement and/or embodiment. That is, a value may be described as HIGH in one arrangement although it may be LOW if provided in another arrangement. The terms HIGH and LOW may be used in an intended generic sense. Embodiments and arrangements may be implemented with a total/partial reversal of any of the HIGH and LOW signals by a change in logic.

Where specific details (e.g., circuits) are set forth in order to describe example embodiments of the invention, it should be apparent to one skilled in the art that the invention can be practiced without, or with variation of, these specific details. Finally, it should be apparent that differing combinations of hard-wired circuitry may be used to implement embodiments of the present invention. That is, the present invention is not limited to any specific combination of hardware.

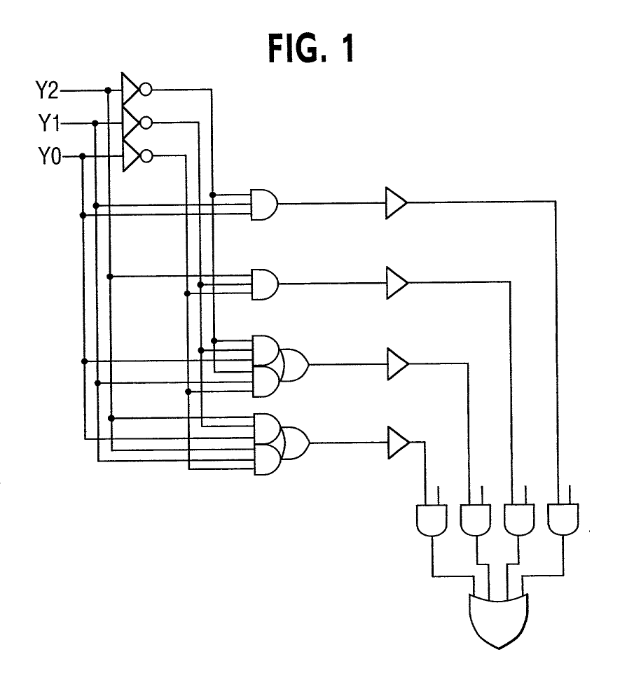

One method for multiplying together two digital numbers (i.e., the multiplicand and the multiplier) entails the use of a Booth encoder/selector circuit. The concept behind Booth encoder/selector circuits is to subdivide the multiplier into groups of bits. These bits may then be encoded and used to select appropriate bit patterns that reduce the number of partial products. An example of a Booth encoder/selector circuit is shown in FIG. 1. Although a multiplier utilizing this Booth encoder/selector circuit may be faster than a conventional multiplier, it nevertheless may take a certain amount of time for the signals to be processed by the Booth encoder/selector circuit. For instance, the Booth encoder/selector circuit shown in FIG. 1 may have a critical path that takes approximately an equivalent of nine NAND gate delays to complete. The critical path may be defined as the logical flow through a circuit that takes the longest time to complete. The critical path may be the limiting factor for how fast a circuit can complete its processing and may be used as a measure of that circuit's speed.

Designers have attempted to shorten the critical path by optimizing the encoder circuitry and/or by optimizing the selector circuitry.

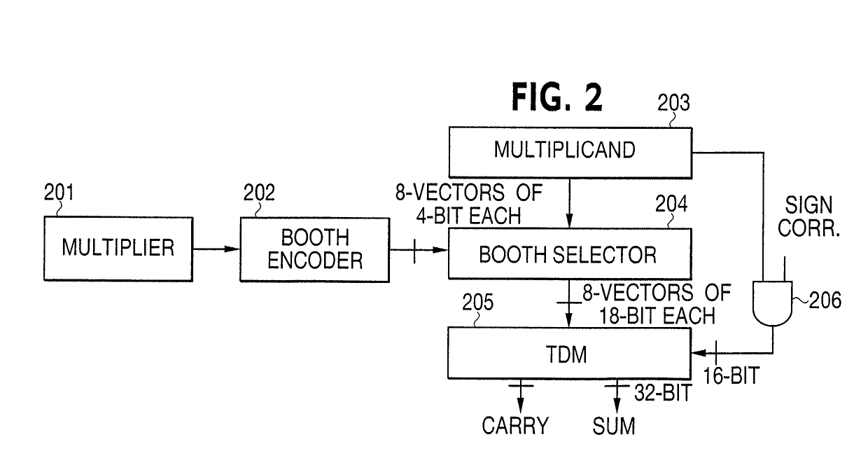

FIG. 2 is a block diagram of a 16×16 bit multiplier circuit. The 16-bit multiplier value is input via an interface 201 to eight Booth encoders 202. Meanwhile, the 16-bit multiplicand value is input via an interface 203 to eight Booth selectors 204. The Booth encoders 202 control the outputs of the Booth selectors 204. Each Booth selector 204 produces an 18-bit partial product. The Booth selector 204 produces multiplicand times 1, 2, −1, or 2 depending on the output of the Booth encoder 202. A three dimensional reduction method (TDM) adder array 205 may be used to perform the carry free addition of the partial products generated by the Booth selector 204. An AND circuit 206 may be used to perform sign correction.

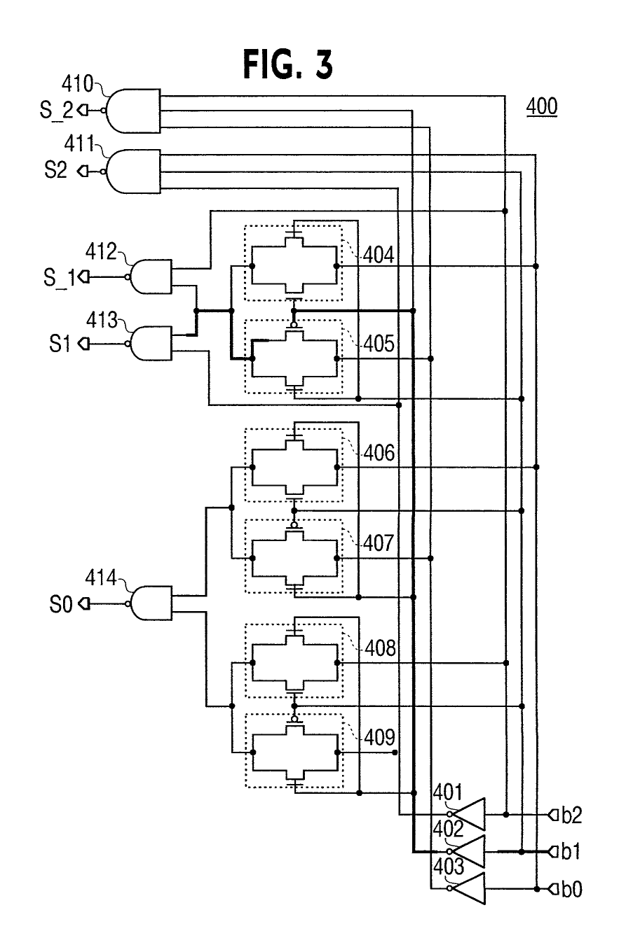

FIG. 3 is a circuit diagram of a Booth encoder circuit according to one arrangement disclosed in U.S. Pat. No. 6,301,599. As shown in FIG. 3, three bits of the multiplier are supplied as inputs b0, b1, and b2 to the Booth encoder 400. The outputs from the Booth encoder 400 are shown as s0, s1, s_{—}1, s2 and s_{—}2. The 3-bit input multiplier should output an encoded signal indicating the conditions as shown in the following Table 1.

3-Bit Multiplier

| b2 | b1 | b0 | Encoder Output |
|---|---|---|---|
| 0 | 0 | 0 | 0 |
| 0 | 0 | 0 | x1 |
| 0 | 1 | 0 | x1 |
| 0 | 1 | 1 | x2 |
| 1 | 0 | 0 | x-2 |
| 1 | 0 | 1 | x-1 |
| 1 | 1 | 0 | x-1 |
| 1 | 1 | 1 | 0 |

In other words, whenever a 3-bit multiplier of 000 or 111 is received, the Booth encoder outputs a signal indicating that the multiplicand should be multiplied by 0. Whenever the 3-bit multiplier is 001 or 010, then the Booth encoder outputs a signal indicating that the multiplicand should be multiplied by 1. If the 3-bit multiplier is 011, the Booth encoder outputs a signal indicating that the multiplicand should be multiplied by 2. Likewise, if the 3-bit multiplier is 100, the Booth encoder outputs a signal indicating that the multiplicand should be multiplied by negative 2. If the 3-bit multiplier is either 101 or 110, then the Booth encoder outputs a signal indicating that the multiplicand should be multiplied by negative 1.

As shown in FIG. 3, the encoder outputs of 0, x1, x−1, x2, and x−2 may be represented by the s0, s1, s_{—}1, s2, and s_{—}2 output bits. The relationship between 0, 1, x1, x−1, x2, and x−2 versus s0, s1, s_{—}1, s2, and s_{—}2 is provided in the following Table 2.

| Encoder Output | s0 | s1 | s_1 | s2 | s_2 |
|---|---|---|---|---|---|
| 0 | 1 | 0 | 0 | 0 | 0 |
| x1 | 0 | 1 | 0 | 0 | 0 |
| x-1 | 0 | 0 | 1 | 0 | 0 |
| x2 | 0 | 0 | 0 | 1 | 0 |
| x_2 | 0 | 0 | 0 | 0 | 1 |

In other words, if the multiplicand is supposed be multiplied by zero, then the s0 line is set to “1” while the s1, s_{—}1, s2, and s_{—}2 lines are set to “0's”. If the multiplicand is supposed to be multiplied by one, then the s1 line is set to “1” while the s0, s_{—}1, s2, and s_{—}2 lines are set to “0's”. If the multiplicand is supposed to be multiplied by negative 1, then the s_{—}1 line is set to “1” while the s0, s1, s2 and s_{—}2 lines are set to “0's”. If the multiplicand is supposed to be multiplied by two, then the s2 line is set to “1” while the s0, s1, s_{—}1 and s_{—}2 lines are set to “0's”. If the multiplicand is supposed to be multiplied by negative two, then the s_{—}2 line is set to “1” while the s0, s1, s_{—}1 and s2 lines are set to “0's”.

Combining Table 1 and Table 2 shows relationships between the 3-bit multiplier (b0, b1 and b2) and the Booth encoder's output bits (s0, s1, s_{—}1, s2 and s_{—}2). This relationship is provided in the following Table 3.

| 3-Bit Multiplier | | | Booth Encoder Outputs | | | | |
|---|---|---|---|---|---|---|---|
| b2 | b1 | b0 | s0 | s1 | s_1 | s2 | s_2 |
| 0 | 0 | 0 | 1 | 0 | 0 | 0 | 0 |
| 0 | 0 | 1 | 0 | 1 | 0 | 0 | 0 |
| 0 | 1 | 0 | 0 | 1 | 0 | 0 | 0 |
| 0 | 1 | 1 | 0 | 0 | 0 | 1 | 0 |
| 1 | 0 | 0 | 0 | 0 | 0 | 0 | 1 |
| 1 | 0 | 1 | 0 | 0 | 1 | 0 | 0 |
| 1 | 1 | 0 | 0 | 0 | 1 | 0 | 0 |
| 1 | 1 | 1 | 1 | 0 | 0 | 0 | 0 |

In other words, whenever the three multiplier bits are 000 or 111, then the Booth encoder 400 generates a “1” on the s0 line and “0's” on the s1, s_{—}1, s2 and s_{—}2 lines. Whenever the three multiplier bits are 001 or 010, the Booth encoder 400 generates a “1” on the s1 line and “0's” on the s0, s_{—}1, s2 and s_{—}2 lines. Whenever the three multiplier bits are 011, the Booth encoder 400 generates a “1” on the s2 line and “0's” on the s0, s1, s_{—}1, and s_{—}2 lines. Whenever the three multiplier bits are 100, the Booth encoder 400 generates a “1” on the s_{—}2 line and “0's” on the s0, s1, s_{—}1 and s2 lines. And whenever the three multiplier bits are 101 or 110, the Booth encoder 400 generates a “1” on the s_{—}1 line and “0's” on the s0, s1, s2 and s_{—}2 lines.

The logic used to accomplish the encoding in Table 3 will now be described. FIG. 3 shows one arrangement to perform the encoding by including three inverters 401-403, six pass gates 404-409, two three-input NAND gates 410-411, and three two-input NAND gates 412-414. The pass gates 404-409 may include an NMOS transistor coupled in parallel with a PMOS transistor. These may be coupled together as follows. The multiplier bit on the b0 line is coupled as an input to the pass gate 406, the pass gate 404, and the NAND gate 411. The multiplier bit on the b0 line is also inverted by the inverter 403 and coupled as an input to the pass gates 407 and as an input to the pass gate 405. The inverted b0 bit is also input to the NAND gate 410. The multiplier bit on the b1 line is coupled to the gate of the PMOS transistor of the pass gate 408 and to the gate of the NMOS transistor of the pass gate 409. The multiplier bit on the b1 line is also coupled to the gate of the PMOS transistor of the pass gate 406 and to the gate of the NMOS transistor of the pass gate 407 In addition, the multiplier bit on the b1 line is coupled to the gate of the PMOS transistor of the pass gate 405 and to the gate of the NMOS transistor of the pass gate 404. The multiplier bit on the b1 line is also coupled as one of the inputs to the NAND gate 411. The multiplier bit on the b1 line is inverted by the inverter 402 and coupled to the gate of the PMOS transistor of the pass gate 409, the gate of the PMOS transistor of the pass gate 407, the gate of the NMOS transistor of the pass gate 405, the gate of the PMOS transistor of the pass gate 404, and as one of the inputs to the NAND gate 410. The multiplier bit on the b2 line is input to the pass gate 408 and is input to the NAND gate 412 and the NAND gate 410. The b2 gate is also inverted by the inverter 401. The inverted b2 bit is then coupled to the input of the pass gate 409 and is input to the NAND gate 413 and the NAND gate 411. The outputs from the pass gates 408 and 409 are coupled as an input to the NAND gate 414 The outputs from the pass gates 406 and 407 are coupled as the other input to the NAND gate 414. The outputs from the pass gates 404 and 405 are coupled as an input to the NAND gate 412 as well as an input to the NAND gate 413. The output from the NAND gate 414 is s0; the output from the NAND gate 413 is s1; the output from the NAND gate 412 is s_{—}1; the output from the NAND gate 411 is s2; and the output from the NAND gate 410 is s_{—}2.

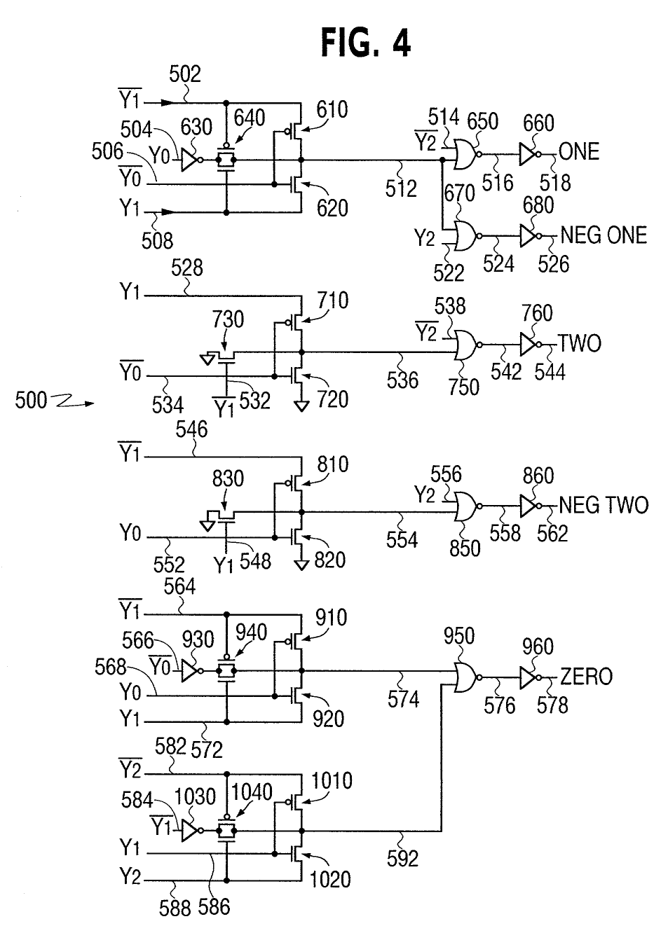

Embodiments of the present invention may provide a Booth encoder circuit as will be described with respect to at least FIG. 4. The Booth encoder circuit may include a plurality of CMOS transistors to receive a plurality of multiplier bits (Y0, Y1, Y2) and complements (\overline{Y0}, \overline{Y1} and \overline{Y2}) of the plurality of multiplier bits. The Booth encoder circuit may also include a plurality of logic gates (or circuits) coupled to the plurality of transistors to output Booth encoded signals.

FIG. 4 shows a Booth encoder circuit 500 to perform encoding according to an example embodiment of the present invention. More specifically, FIG. 4 shows logic to accomplish the encoding set forth in Table 3. Other embodiments and configurations are also within the scope of the present invention. For ease of illustration, each signal line in FIG. 4 is labeled with a three digit number beginning with 5, whereas the circuit components are numbered starting with 6, 7, 8, 9 or 10.

In the FIG. 4 embodiment, three bits (Y0, Y1, Y2) of the multiplier are input to the Booth encoder circuit 500. The three bits (Y0, Y1, Y2) may correspond to the bits b0, b1 and b2 discussed above with respect to Tables 1-3. Embodiments of the present invention may utilize a double rail system in which signals (e.g. complements) corresponding to the bits \overline{Y0}, \overline{Y1} and \overline{Y2} are created (outside of the Booth encoder circuit) from the bits Y0, Y1 and Y2, respectively. The outputs of the Booth encoder circuit 500 are shown as the signals ZERO, ONE, NEGONE, TWO and NEGTWO. The 3-bit input multiplier outputs an encoded signal indicating the conditions of Table 1.

As shown in FIG. 4, the \overline{Y1} value is input along a signal line 502 to a PMOS transistor 610. The \overline{Y0} value is input along a signal line 504 to an inverter 630. The inverted value is then provided to a set of transistors 640. The set of transistor 640 may include a PMOS transistor and an NMOS transistor coupled in parallel. The \overline{Y0} value may be input along a signal line 506 to a gate of an NMOS transistor 620 and to a gate of the PMOS transistor 610. Additionally, the \overline{Y1} value is input along a signal line 508 to the NMOS transistor 620 and to a gate of the NMOS transistor of the set of transistors 640. The transistors 610, 620, 640 and the inverter 630 may form a first subcircuit. Based on the input signals, the first subcircuit may provide a signal along a signal line 512 to one input of a NAND gate 650. The \overline{Y2} value is also input along a signal line 514 to another input of the NAND gate 650. An output of the NAND gate 650 is provided along a signal line 516 to an inverter 660 that provides an output signal along a signal line 518. The signal output along the signal line 518 is a Booth encoding signal corresponding to ONE. The signal along the signal line 516 corresponds to PRE_ONE. Additionally, the signal provided along the signal line 512 is provided to one input of a NAND gate 670. The \overline{Y2} value is provided along a signal line 522 to another input of the NAND gate 670. Based on the inputs, the NAND gate 670 provides an output signal along a signal line 524 to an inverter 680 that provides an output signal along a signal line 526. The signal output along the signal line 526 is a Booth encoding signal corresponding to NEGONE. The signal along the signal line 524 corresponds to PRE_NEGONE.

FIG. 4 additionally shows the Y1 value is input along a signal line 528 to a PMOS transistor 710. The \overline{Y1} value is input along a signal line 532 to a gate of an NMOS transistor 730. Additionally, the \overline{Y0} value is input along a signal line 534 to a gate of an NMOS transistor 720 and to a gate of the PMOS transistor 710. The transistors 710, 720 and 730 may form a second subcircuit. Based on the input signals, the second subcircuit may provide a signal along a signal line 536 to one input of a NAND gate 750. The \overline{Y2} value is also input along a signal line 538 to another input of the NAND gate 750. An output of the NAND gate 750 is provided along a signal line 542 to an inverter 760 that provides an output signal along a signal line 544. The output signal provided along the signal line 544 is a Booth encoding signal corresponding to TWO. The signal along the signal line 542 corresponds to PRE_TWO.

The \overline{Y1} value is input along a signal line 546 to a PMOS transistor 810. The Y1 value is input along a signal line 548 to a gate of an NMOS transistor 830. Additionally, the Y0 value is input along a signal line 552 to a gate of an NMOS transistor 820 and to a gate of the PMOS transistor 810. The transistors 810, 820 and 830 may form a third subcircuit. Based on the input signals, the third subcircuit may provide a signal along a signal line 554 to one input of a NAND gate 850. The Y2 value is also input along a signal line 556 to another input of the NAND gate 850. An output of the NAND gate 850 is provided along a signal line 558 to an inverter 860 that provides an output signal along a signal line 562. The output signal provided along the signal line 562 is a Booth encoding signal corresponding to NEGTWO. The signal along the signal line 558 corresponds to PRE_NEGTWO.

The \overline{Y1} value is also input along a signal line 564 to a PMOS transistor 910. The \overline{Y0} value is input along a signal line 566 to an inverter 930. The inverted value is then provided to a set of transistors 940. The set of transistor 940 may include a PMOS transistor and an NMOS transistor coupled in parallel. The Y0 value may be input along a signal line 568 to a gate of an NMOS transistor 920 and to a gate of the PMOS transistor 910. Additionally, the Y1 value is input along a signal line 572 to the NMOS transistor 920 and to a gate of the NMOS transistor of the set of transistors 940. The transistors 910, 920, 940 and the inverter 930 may form a fourth subcircuit. Based on the input signals, the fourth subcircuit may provide a signal along a signal line 574 to one input of a NAND gate 950.

The \overline{Y2} value is input along a signal line 582 to a PMOS transistor 1010. The \overline{Y1} value is input along a signal line 584 to an inverter 1030. The inverted value is then provided to a set of transistors 1040. The set of transistor 1040 may include a PMOS transistor and an NMOS transistor coupled in parallel. The \overline{Y1} value may be input along a signal line 586 to a gate of an NMOS transistor 1020 and to a gate of the PMOS transistor 1010. Additionally, the Y2 value is input along a signal line 588 to the NMOS transistor 1020 and to a gate of the NMOS transistor of the set of transistors 1040. The transistors 1010, 1020, 1040 and the inverter 1030 may form a fifth subcircuit. Based on the input signals, the fifth subcircuit may provide a signal along a signal line 592 to another input of the NAND gate 950.

An output of the NAND gate 950 is provided along a signal line 576 to an inverter 960 that provides an output signal along a signal line 578. The signal output along the signal line 578 is a Booth encoding signal corresponding to ZERO. The signal along the signal line 576 corresponds to PRE_ZERO.

In the FIG. 4 embodiment, one of the five Booth encoding signals (ZERO, ONE, NEGONE, TWO and NEGTWO) is HIGH while the remaining signals are LOW. The configuration shown in FIG. 4 allows each of the five output signals (ZERO, ONE, NEGONE, TWO and NEGTWO) to be switching at the same time so as to minimize wasting power in a short-circuit current in a later 5-to-1 multiplexer.

Embodiments of the present invention may include a set of static XOR circuitry decoding the bits in the multiplier number in parallel. Embodiments may also include NAND gates and inverters to generate the Booth encoding signals with matched delay. The delay-matched encoded signals may reduce the switching noise in downstream Partial Product muxing circuitry. Embodiments of the present invention may use fewer transistors (such as 54 transistors) as compared with disadvantageous arrangements (having 68 transistors), thereby saving layout area. Embodiments of the present invention may be implemented in static CMOS circuitry that uses lower power than dynamic implementations. Embodiments of the present invention may have a three-gate delay as compared to a dynamic disadvantageous arrangement having a four-gate delay. Additionally, embodiments of the present invention may not have to wait for clock synchronization as in disadvantageous dynamic implementations so that the speed may be faster.

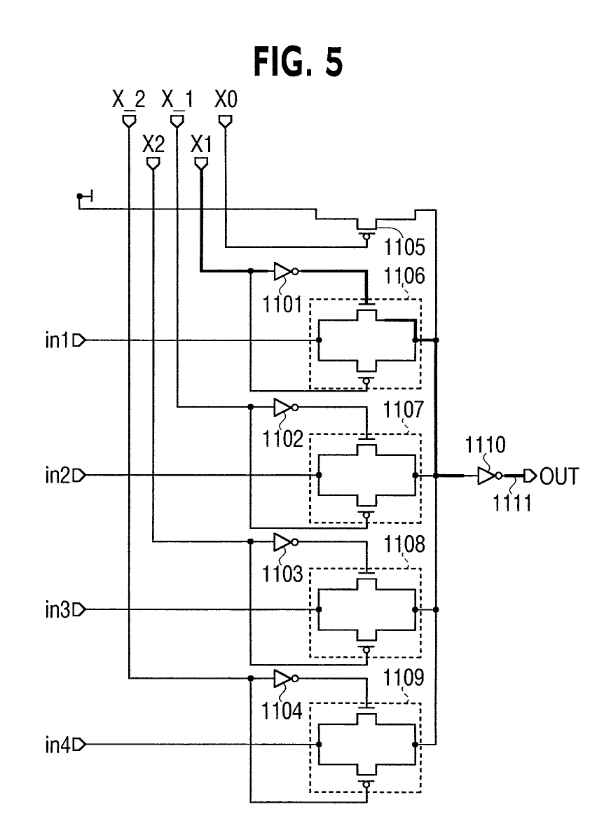

In order to complete a full understanding of Booth encoding, a selecting circuit will now be described with respect to FIG. 5. A similar arrangement is shown in U.S. Pat. No. 6,301,599. The circuit is intended to be coupled to the circuitry shown in FIG. 3. However, this circuit may also be coupled to the embodiment shown in FIG. 4. For ease of illustration, FIG. 5 will be described as being coupled to FIG. 3 and thereby utilizing the signals of FIG. 3.

FIG. 5 is a circuit diagram of a 5:1 multiplexer that may be used to perform the function of a Booth selector circuit 1100 according to one arrangement. Other arrangements are also possible. One skilled in the art would understand that each bit of the multiplicand may include its own 5:1 multiplexer. However for illustration purposes, only one 5:1 multiplexer is shown in FIG. 5. For this 5:1 multiplexer, an output along a signal line 1111 is based on the bits b0, b1 and b2 of the multiplier.

The Booth selector circuit 1100 may be coupled to the Booth encoder circuit 400 of FIG. 3. The s0, s1, s_{—}1, s2, and s_{—}2 outputs (FIG. 3) from the Booth encoder circuit 400 may be coupled as the inputs x₀, x₁, x_{—}1, x2, and x_{—}2, respectively, of the Booth selector circuit 1100 (FIG. 5). Alternatively, the PRE_ZERO, PRE_ONE, PRE_NEGONE, PRE_TWO, and PRE_NEGTWO signals (FIG. 4) from the Booth encoder circuit 500 may be coupled as the inputs x0, x1, x_{—}1, x2, and x_{—}2, respectively, of the Booth selector circuit 1100 (FIG. 5).

The x0, x1, x_{—}1, x2, and x_{—}2 inputs may be used to select from one of five possible multiplicand bits: ground, in1, in2, in3, or in4 for output (OUT) on signal line 1111. If ground is selected, this indicates multiplying the multiplicand by 0 (i.e., x0). Consequently, the output will be all “0's”. Otherwise, if in1 is selected, this indicates multiplying the multiplicand by one (i.e., x1). In other words, the multiplicand bit is passed through unchanged. If in2 is selected, this indicates multiplying the multiplicand by negative 1 (i.e., x_{—}1). In other words, the multiplicand is inverted before being output. If in3 is selected, this indicates multiplying the multiplicand by two (i.e., x2). This is accomplished by arithmetically shifting the multiplicand to the left by one bit before being output. If in4 is selected, this indicates that the multiplicand is to be multiplied by negative 2 (i.e., x_{—}2). This is accomplished by performing an arithmetic shift left on the multiplicand and then inverting the result. Since in2 is the inverse of in1, one can provide the in2 signal by simply coupling to the in1 line with an intervening inverter. Likewise, since in4 is the inverse of in3, one can provide the in4 signal by simply coupling to the in3 line with an intervening inverter.

Table 4 (below) shows the relationship between the control inputs x0, x1, x_{—}1, x2, and x_{—}2 to the selected output for the Booth selector circuit 1100.

| x0 | x1 | x_1 | x2 | x_2 | Output |
|---|---|---|---|---|---|
| 1 | 0 | 0 | 0 | 0 | Ground |
| 0 | 1 | 0 | 0 | 0 | in1 |
| 0 | 0 | 1 | 0 | 0 | in2 |
| 0 | 0 | 0 | 1 | 0 | in3 |
| 0 | 0 | 0 | 0 | 1 | in4 |

In other words, when the received control inputs are 10000, then the output is ground. If the received control inputs are 01000, then the output is in1. If the received inputs are 00100, then the output is in3. And if the received control inputs are 00001, then the output is in4.

The Booth selector circuit 1100 may include five inverters 1101-1104 and 1110; an NMOS transistor 1105; and four pass gates 1106-1109. This logic may be connected together as follows. The x0 bit on the x0 line is coupled to the gate of the NMOS transistor 1105. The x1 bit on the x1 line is coupled as an input to the inverter 1101 and is also coupled to the gate of the NMOS transistor of the pass gate 1106. The output from the inverter 1101 is coupled to the gate of the PMOS transistor of the pass gate 1106. The x_{—}1 bit of the x_{—}1 line is coupled as an input to the inverter 1102 and to the gate of the NMOS transistor of the pass gate 1107. The output from the inverter 1102 is coupled to the gate of the PMOS transistor of the pass gate 1107. The x2 bit of the x2 line is coupled as an input to the inverter 1103 and to the gate of the NMOS transistor of the pass gate 1108. The output from the inverter 1103 is coupled to the gate of the PMOS transistor of the pass gate 1108. The x_{—}2 bit of the x_{—}2 line is coupled as an input to the inverter 1104 and to the gate of the NMOS transistor of the pass gate 1109. The output from the inverter 1104 is coupled to the gate of the PMOS transistor of the pass gate 1109. The drain of the NMOS transistor 1105 is coupled to ground, and its source is coupled to the input of the inverter 1110. The in1 line is coupled to the input of the pass gate 1106. The in2 line is coupled to the input of the pass gate 1107. The in3 line is coupled to the input of the pass gate 1108. The in4 line is coupled to the input of the pass gate 1109. The outputs from the four pass gates 1106-1109 are all coupled to the input of the inverter 1110. The output from the inverter 1110 provides the output from the Booth selector circuit 1100.

Embodiments of the present invention have been described with respect to a Booth encoder circuit that includes logic to receive a plurality of multiplier bits and complements of the multiplier bits. The logic may output Booth encoded signals based on the multiplier bits and complements of the multiplier bits. The logic may include a plurality of transistors, a plurality of NAND circuits and a plurality of inverters. The logic may be configured to have a maximum of three gate delays.

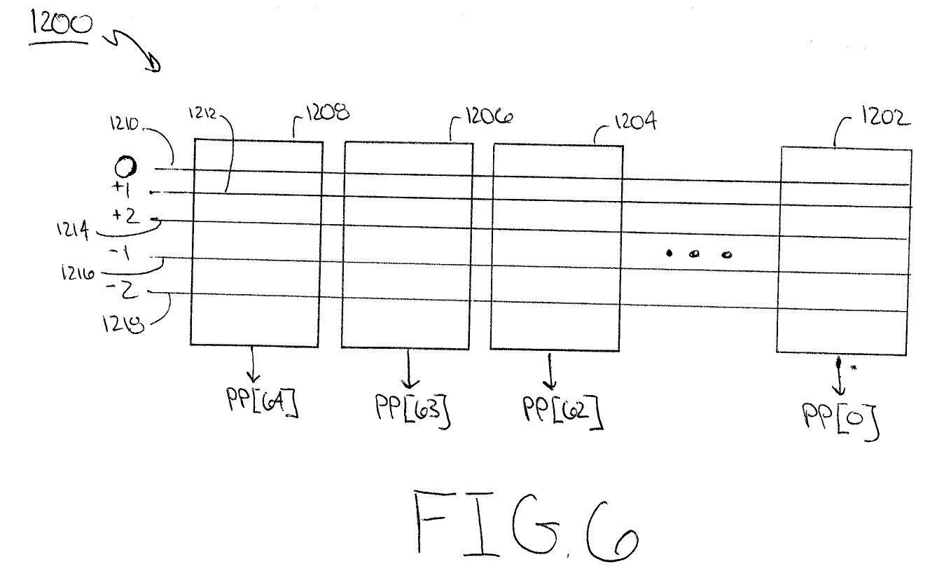

FIG. 6 is a circuit diagram of a plurality of 5:1 multiplexers that may perform the function of a booth selector circuit according to one arrangement. Other arrangements are also possible. The FIG. 6 circuit diagram may be coupled to outputs of the FIG. 4 (or FIG. 3) circuit diagrams. One skilled in the art would understand that each bit of the multiplicand may include its own 5:1 multiplexer. For example, a multiplexer 1202 may correspond to a zero bit of the multiplicand. Each of multiplexers 1204, 1206 and 1208 also may separately correspond to one bit of the multiplicand. Each of the multiplexers 1202, 1204, 1206 and 1208 may receive signals along five select lines so as to produce a partial product output from the respective multiplexers. Each multiplexer may output one bit of the partial product (PP[x]) based on the received input select signal. For example, each of the multiplexers 1202, 1204, 1206 and 1208 may be coupled to a signal line 1210 (representing a select 0 signal), a signal line 1212 (representing a select +1 signal), a signal line 1214 (representing a +2 signal), a signal line 1216 (representing a −1 signal), and a signal line 1218 (representing a select −2 signal). As shown in FIG. 6, the multiplexer 1202 may output a PP[0] bit, the multiplexer 1204 may output a PP[62] bit, the multiplexer 1206 may output a PP[63] bit and the multiplexer 1208 may output a PP[64] bit. The multiplexers and partial products output for each of bits 1 to 62 are not shown in FIG. 6 for ease of illustration.

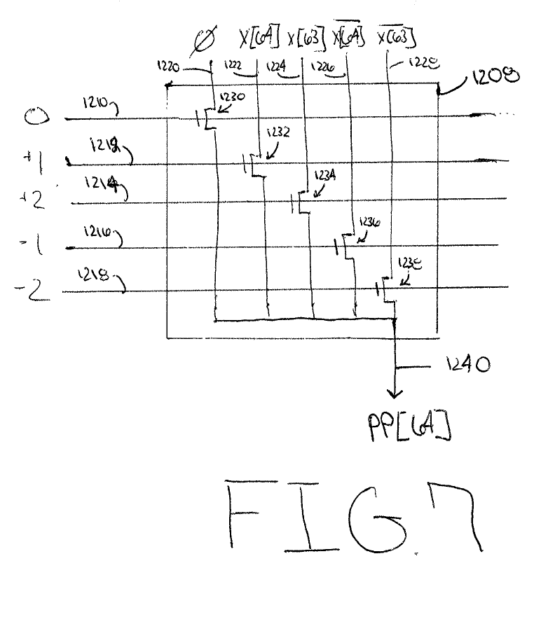

FIG. 7 is a circuit diagram of one 5:1 multiplexer according to an example arrangement. Other arrangements are also possible. FIG. 7 is a circuit diagram of the multiplexer 1208 shown in FIG. 6. As shown, the multiplexer 1208 may include an NFET (n-gate field effect transistor) 1230 coupled along a signal line 1220, an NFET 1232 coupled along a signal line 1222, an NFET 1234 coupled along a signal line 1224, an NFET 1236 coupled along a signal line 1226 and an NFET 1238 coupled along a signal line 1228. The NFET 1230 may receive a signal (i.e., a GROUND signal) along the signal line 1220. The NFET 1232 may receive a signal (represented as X[64]) along the signal line 1222. The NFET 1234 may receive a signal (represented as X[63]) along the signal line 1224. The NFET 1236 may receive a signal (represented as \overline{X[64]}) along the signal line 1226. Finally, the NFET 1238 may receive a signal (represented as \overline{X[63]}) along the signal line 1228.

In a similar manner as shown above with respect to FIG. 6, the select 0 signal may be applied along the signal line 1210 to the NFET 1230, the select +1 signal may be applied along the signal line 1212 to the NFET 1232, the select +2 signal may be applied along the signal line 1214 to the NFET 1234, the select −1 signal may be applied along the signal line 1216 to the NFET 1236 and the select −2 signal may be applied along the signal line 1218 to the NFET 1238. One of the select signals may be HIGH to thereby only turn ON one of the respective NFETs 1230, 1232, 1234, 1236 and 1238. By turning ON one of the NFETs, a signal may pass to a signal line 1240 and be output as the partial product for that respective bit (such as bit 64) of the multiplicand. For example, if the NFET 1230 is turned ON then a ground signal may pass along the signal line 1240. If the NFET 1232 is turned ON then the signal represented as X[64] may pass along the signal line 1240. If the NFET 1234 is turned ON then the signal represented as X[63] may pass along the signal line 1240. If the NFET 1236 is turned ON then the signal represented as \overline{X[64]} may pass along the signal line 1240. If the NFET 1238 is turned ON then the signal represented as \overline{X[63]} may pass along the signal line 1240.

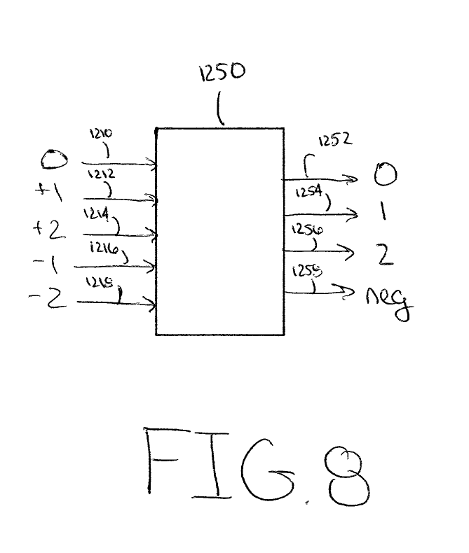

FIG. 8 shows a booth recoder circuit according to one arrangement. Other arrangements are also possible. More particularly, FIG. 8 shows one arrangement in which five select signals (0, +1, +2, −1 and −2) may be recoded to four select signals. The four recoded Booth signals may be 0, 1, 2 and NEG, for example. That is, the select signals 0, +1, +2, −1 and −2 may be input to a recoder circuit 1250 along the signal lines 1210, 1212, 1214, 1216 and 1218, respectively. The recoder circuit 1250 may include logic to transpose the input select signals to one or more of the output select signals 0, 1, 2 and NEG along signal lines 1252, 1254, 1256 and 1258, respectively. For example, a select +1 signal on the signal line 1212 may be recoded to a HIGH signal on the signal line 1254 (representing the select 1 signal). Similarly, a select −1 signal on the signal line 1216 may be recoded to a HIGH signal on the signal line 1254 (representing the select 1 signal) and to a HIGH signal on the signal line 1258 (representing the select NEG signal). Although not shown in FIG. 8, a \overline{NEG} signal may be created from the NEG signal. The recoder circuit 1250 thereby allows the use of less signal lines to be coupled to the respective multiplexer.

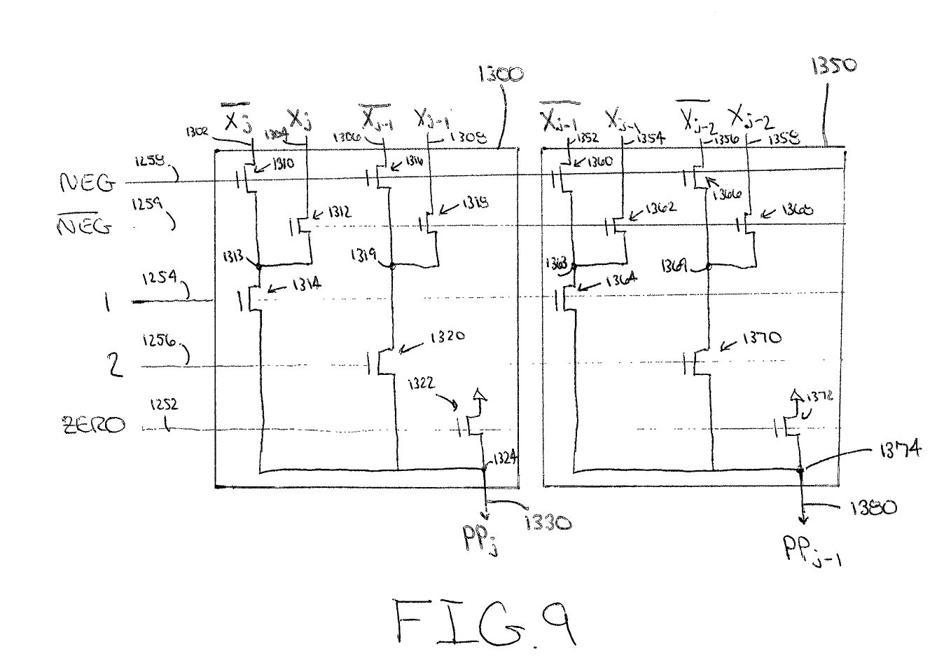

FIG. 9 is a circuit diagram of two adjacent multiplexers in a partial products generator circuit according to one arrangement. Other arrangements are also possible. More specifically, FIG. 9 shows that the recoded select signals may be input to two adjacent multiplexers 1300 and 1350. Additional multiplexers are not shown in FIG. 9 for ease of illustration. For example, the select NEG signal may be applied along a signal line 1258, the select \overline{NEG} signal may be applied along a signal line 1259, the select 1 signal may be applied along the signal line 1254, the select 2 signal may be applied along the signal line 1256 and the select ZERO signal may be applied along the signal line 1252. The select NEG signal, the select \overline{NEG} signal, the select 1 signal and the select 2 signal may also be obtained directly from the Y0, Y1, Y2 bits of the multiplier (FIG. 4) rather than recoding to five intermediate signals as shown in FIGS. 4 and 8.

The multiplexer 1300 may receive signals along signal lines 1302, 1304, 1306 and 1308 corresponding to bits of the multiplicand. More specifically, a signal represented as \overline{Xj} may be received along the signal line 1302, a signal represented as Xⱼ may be received along the signal line 1304, a signal represented as \overline{Xⱼ₌₁} may be received along the signal line 1306 and a signal represented as \overline{Xⱼ₋₁} may be received along the signal line 1308. An NFET 1310 may be coupled along the signal line 1302 and to a node 1313. Similarly, an NFET 1312 may be coupled along the signal line 1304 and to the node 1313. An NFET 1316 may be coupled along the signal line 1306 and to a node 1319. An NFET 1318 may be coupled along the signal line 1308 and to the node 1319. Still further, an NFET 1314 may be coupled between the node 1313 and a node 1324. Similarly, an NFET 1320 may be coupled between the node 1319 and the node 1324. An NFET 1322 may be coupled between GROUND and the node 1324. Based on the select signals input to the multiplexer 1300, respective ones of the NFETs 1310, 1312, 1314, 1316, 1318, 1320 and 1322 may be turned ON to allow signals to pass to a signal line 1330 and be output as the partial product for that respective bit (i.e., bit j) of the multiplicand. Operations of the NFETs 1310, 1312, 1314, 1316, 1318, 1320 and 1322 may be based on the respective select signals input to the multiplexer 1300 along the signal lines 1258, 1259, 1254, 1256 and 1252. More specifically, the NFETs 1310 and 1316 may turn ON in response to the select NEG signal on the signal line 1258. The NFETs 1312 and 1318 may turn ON in response to the select \overline{NEG} signal on the signal line 1259. The NFET 1314 may turn ON in response to the select 1 signal on the signal line 1254. The NFET 1320 may turn ON in response to the select 2 signal on the signal line 1256. The NFET 1322 may turn ON in response to the select 0 signal on the signal line 1252.

The multiplexer 1350 may also receive select signals along signal lines 1352, 1354, 1356 and 1358 corresponding to bits of the multiplicand. More specifically, the signal represented as \overline{Xⱼ₋₁} may be received along the signal line 1352, the signal represented as Xⱼ₋₁ may be received along the signal line 1354, the signal represented as \overline{Xⱼ₋₂} may be received along the signal line 1356 and the signal represented as Xⱼ₋₂ may be received along the signal line 1358. An NFET 1360 may be coupled along the signal line 1352 and to a node 1363. An NFET 1362 may be coupled along the signal line 1354 and to the node 1363. An NFET 1366 may be coupled along the signal line 1356 and to a node 1369. An NFET 1368 may be coupled along the signal line 1358 and to the node 1369. Similarly, an NFET 1364 may be coupled between the node 1363 and a node 1374. An NFET 1370 may be coupled between the node 1369 and the node 1374. An NFET 1372 may be coupled between GROUND and the node 1374. Based on the select signals input to the multiplexer 1350, respective ones of the NFETs 1360, 1362, 1364, 1366, 1368, 1370 and 1372 may be turned ON to allow signals to pass to a signal line 1380 and be output as the partial product for that respective bit (i.e., bit j−1) of the multiplicand. Operations of the NFETs 1360, 1362, 1364, 1366, 1368, 1370 and 1372 may be based on the respective select signals input to the multiplexer 1350 along the signal lines 1258, 1259, 1254, 1256 and 1252. More specifically, the NFETs 1360 and 1366 may turn ON in response to the select NEG signal on the signal line 1258. The NFETs 1362 and 1368 may turn ON in response to the select \overline{NEG} signal on the signal line 1259. The NFET 1364 may turn ON in response to the select 1 signal on the signal line 1254. The NFET 1370 may turn ON in response to the select 2 signal on the signal line 1256. The NFET 1372 may turn ON in response to the select 0 signal on the signal line 1252.

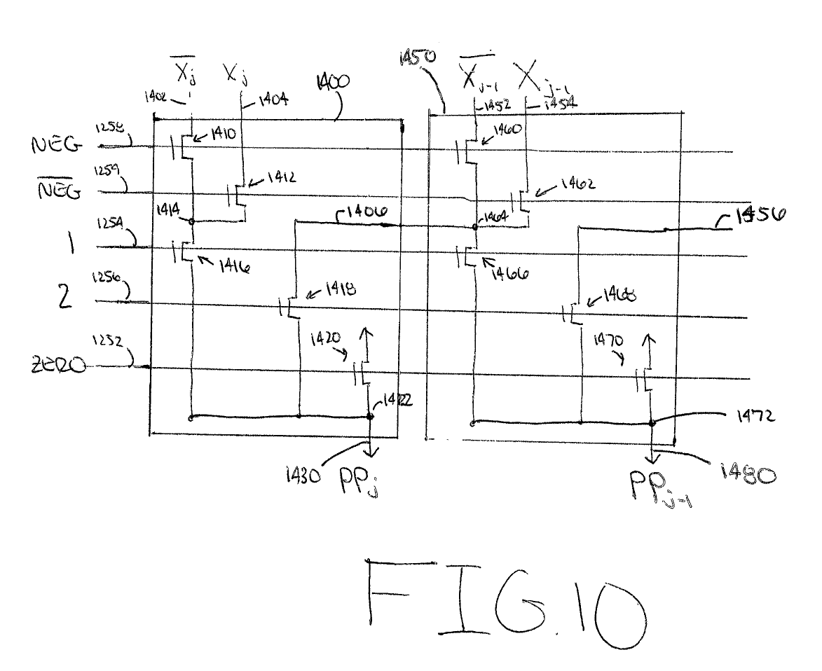

FIG. 10 is a circuit diagram of two adjacent multiplexers in a partial products generator circuit according to an example embodiment of the present invention. Other embodiments and configurations are also within the scope of the present invention. Additional multiplexers are not shown in FIG. 10 for ease of illustration. More specifically, FIG. 10 shows that the recoded select signals (such as from FIG. 8) may be input to multiplexers 1400 and 1450 (such as the multiplexers 1208 and 1206 shown in FIG. 6). For example, the select NEG signal may be applied along the signal line 1258, the select \overline{NEG} signal may be applied along the signal line 1259, the select 1 signal may be applied along the signal line 1254, the select 2 signal may be applied along the signal line 1256 and the select ZERO signal may be applied along the signal line 1252.

In this embodiment, the multiplexer 1400 may receive signals along signal lines 1402 and 1404 corresponding to bits of the multiplicand and may receive a signal on signal line 1406 corresponding to multiplexed data from a previous multiplexer. More specifically, a signal represented as \overline{Xj} may be received along the signal line 1402, a signal represented as Xⱼ may be received along the signal line 1404 and a signal from the previous bit (or previous multiplexer) may be received is along the signal line 1406. An NFET 1410 may be coupled along the signal line 1402 and to a node 1414. An NFET 1412 may be coupled along the signal line 1404 and to the node 1414. An NFET 1416 may be coupled between the node 1414 and a node 1422. An NFET 1418 may be coupled between the signal line 1406 and the node 1422. Additionally, an NFET 1420 may be coupled between GROUND and the node 1422. Based on the select signals input to the multiplexer 1400, respective ones of the NFETs 1410, 1412, 1416, 1418 and 1420 may turn ON to allow signals to pass to a signal line 1430 and be output as the partial product (for the j bit) of the multiplicand. Operations of the NFETs 1410, 1412, 1416, 1418 and 1420 may be based on the respective select signals input to the multiplexer 1400. More specifically, the NFET 1410 may operate based on the select NEG signal on the signal line 1258, the NFET 1312 may operate based on the select \overline{NEG} signal on the signal line 1259, the NFET 1416 may operate based on the select 1 signal on the signal line 1254, the NFET 1418 may operate based on the select 2 signal on the signal line 1256 and the NFET 1420 may operate based on the select ZERO signal on the signal line 1252. In this embodiment, the signal passing through the NFET 1418 is based on multiplexed data from the multiplexer 1450.

The multiplexer 1450 may also receive signals along signal lines 1452 and 1454 corresponding to bits of the multiplicand and on signal line 1456 corresponding to multiplexed data from a previous multiplexer. More specifically, a signal represented as \overline{Xⱼ₋₁} may be received along the signal line 1452, a signal represented as \overline{Xⱼ₋₁} may be received along the signal line 1454 and a signal from the previous bit (or previous multiplexer) may be received along the signal line 1456. An NFET 1460 may be coupled along the signal line 1452 and to a node 1464. An NFET 1462 may be coupled along the signal line 1454 and to the node 1464. An NFET 1466 may be coupled between the node 1464 and a node 1472. AN NFET 1468 may be coupled between the signal line 1456 and the node 1472. Additionally, an NFET 1470 may be coupled between GROUND and the node 1472. Based on the select signals input to the multiplexer 1450, respective ones of the NFETs 1460, 1462, 1466, 1468 and 1470 may turn ON to allow signals to pass to a signal line 1480 and be output as the partial product (for the j−1 bit) of the multiplicand. Operations of the NFET 1460, 1462, 1466, 1468 and 1470 may be based on the respective select signals input to the multiplexer 1450. More specifically, the NFET 1460 may operate based on the select NEG signal on the signal line 1258, the NFET 1462 may operate based on the select \overline{NEG} signal on the signal line 1259, the NFET 1466 may operate based on the select 1 signal on the signal line 1254, the NFET 1468 may operate based on the select 2 signal on the signal line 1256 and the NFET 1470 may operate based on the select ZERO signal on the signal line 1252. In this embodiment, the signal passing through the NFET 1468 is based on multiplexed data from a previous multiplexer (not shown in FIG. 10).

Although not shown in FIG. 10, the partial products generating circuit may include a plurality of additional multiplexers similar to the two multiplexers shown in FIG. 10. These additional multiplexers may each be coupled in a similar manner and each to share multiplexed data with a preceeding multiplexer.

Embodiments of the present invention may thereby provide a plurality of NFET devices connected hierarchically so as to perform a desired muxing function and thereby generate the partial products outputs. Rather than directly shifting the lower order inputs in a disadvantageous implementation, embodiments of the present invention may shift multiplexing data. Embodiments of the present invention may utilize fewer transistors per multiplexer as compared with disadvantageous arrangements. In addition to being smaller in area, embodiments of the present invention may provide a smaller and matched loading to the Booth encoded signals. This may provide lower power with faster outputs. For example, in a 64×64 bit high-speed multiplier implementation, the partial product generator circuitry may be used over two thousand times. As such, the smaller area, lower power and faster outputs on the partial products generator may have a big impact to the overall performance of the multiplier.

Embodiments of the present invention may make use of the common mux'ed data (such as on signal lines 1406 and 1456 in FIG. 10) and shift that output to the next bit. This may save two of the seven transistors as may be seen when comparing the FIG. 9 arrangement with the FIG. 10 embodiment. This may also enable a smaller and matched loading to all the Booth encoded signals.

Embodiments of the present invention may provide a partial products generator circuit that includes a first multiplexing device having a plurality of first transistors to receive Booth encoded signals and to provide a first partial products output, and a second multiplexing device having a plurality of transistors to receive the Booth encoded signals and to provide a second partial products output. The second multiplexing device further receives multiplexed data from the multiplexing device when providing the second partial products output.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses may also be apparent to those skilled in the art.

What is claimed is:

1. A circuit comprising:
a booth encoder circuit having a plurality of transistors to receive a plurality of multiplier bits and complements of said plurality of multiplier bits, and a plurality of logic circuits coupled to ones of said plurality of transistors to output Booth encoded signals; and
a partial products generating circuit having a first multiplexing device to receive said Booth encoded signals and to provide a first partial products output, and a second multiplexing device to receive said Booth encoded signals and multiplexed data from said first multiplexing device and to provide a second partial products output.

2. The circuit of claim 1, wherein said plurality of logic circuits includes a recoding circuit.

3. The circuit of claim 1, wherein said first multiplexing device further to receive a signal corresponding to a first bit of a multiplicand and a signal corresponding to a complement of said first bit.

4. The circuit of claim 3, wherein said second multiplexing device further to receive a signal corresponding to a second bit of said multiplicand and a signal corresponding to a complement of said second bit.

5. A Booth encoder circuit comprising:
a plurality of transistors to receive a plurality of multiplier bits and complements of said plurality of multiplier bits; and
a plurality of logic circuits coupled to ones of said plurality of transistors to output Booth encoded signals.

6. The Booth encoder circuit of claim 5, wherein said plurality of transistors comprise a first subcircuit, a second subcircuit, a third subcircuit, and a fourth subcircuit, and said plurality of logic circuits comprise first logic circuits, second logic circuits, third logic circuit and fourth logic circuits, said first subcircuit to receive two of said multiplier bits and complements of two multiplier bits, said first subcircuit to provide a signal to said first logic circuits, said first logic circuits to output two Booth encoded signals.

7. The Booth encoder circuit of claim 6, wherein said second subcircuit to receive one of said multiplier bits and complements of two multiplier bits, said second subcircuit to provide a signal to said second logic circuits, said second logic circuits to output one Booth encoded signal.

8. The Booth encoder circuit of claim 7, wherein said third subcircuit to receive two of said multiplier bits and complements of one multiplier bit, said third subcircuit to provide a signal to said third logic circuits, said third logic circuits to output one Booth encoded signal.

9. The Booth encoder circuit of claim 8, wherein said fourth subcircuit to receive two of said multiplier bits and complements of two multiplier bits, and to provide a signal to said fourth logic circuits based on said two of said multiplier bits and said complements of two multiplier bits, said fifth subcircuit to receive two of said multiplier bits and complements of two multiplier bits and to provide a signal to said fourth logic circuit based on said two of said multiplier bits and said complements of two multiplier bits, said fourth logic circuit to output one Booth encoded signal.

10. The Booth encoder circuit of claim 5, wherein said Booth encoded signals represent:
a multiply by zero;
a multiply by one;
a multiply by negative one;
a multiply by two; and
a multiply by negative two.

11. The Booth encoder circuit of claim 5, wherein said Booth encoded signals are substantially delay-matched at an output of said Booth encoder circuit.

12. The Booth encoder circuit of claim 5, wherein said circuit has a maximum of a three-gate delay from an input of said Booth encoder circuit to an output of said Booth encoder circuit.

13. A multiplier circuit comprising logic to receive a plurality of multiplier bits and complements of said multiplier bits, said logic to output Booth encoded signals based on said multiplier bits and complements of said multiplier bits, said logic configured to have a maximum of three gate delays from an input of said multiplier circuit to an output of said multiplier circuit.

14. The multiplier circuit of claim 13, wherein said logic comprises a plurality of transistors, a plurality of NAND gates and a plurality of inverters.

15. The multiplier circuit of claim 14, wherein said NAND gates comprises two-input NAND circuits.

16. The multiplier circuit of claim 14, wherein at least said plurality of transistors form a first subcircuit, a second subcircuit, a third subcircuit, and a fourth subcircuit, and said NAND gates and said inverters form first logic circuits, second logic circuits, third logic circuit and fourth logic circuits, said first subcircuit to receive two of said multiplier bits and complements of two multiplier bits, said first subcircuit to provide a signal to said first logic circuits, said first logic circuits to output two Booth encoded signals.

17. The multiplier circuit of claim 16, wherein said second subcircuit to receive one of said multiplier bits and complements of two multiplier bits, said second subcircuit to provide a signal to said second logic circuits, said second logic circuits to output one Booth encoded signal.

18. The multiplier circuit of claim 17, wherein said third subcircuit to receive two of said multiplier bits and complements of one multiplier bit, said third subcircuit to provide a signal to said third logic circuits, said third logic circuits to output one Booth encoded signal.

19. The multiplier circuit of claim 18, wherein said fourth subcircuit to receive two of said multiplier bits and complements of two multiplier bits and to provide a signal to said fourth logic circuits based on said two of said multiplier bits and said complements of two multiplier bits, said fifth subcircuit to receive two of said multiplier bits and complements of two multiplier bits and to provide a signal to said fourth logic circuit based on said two of said multiplier bits and said complements of two multiplier bits, said fourth logic circuit to output one Booth encoded signal.

20. The multiplier circuit of claim 13, wherein said Booth encoded signals represent:
a multiply by zero;
a multiply by one;
a multiply by negative one;
a multiply by two; and
a multiply by negative two.

21. The multiplier circuit of claim 13, wherein said Booth encoded signals are substantially delay-matched at an output of said multiplier circuit.

22. A circuit comprising logic to receive a plurality of multiplier bits and complements of said multiplier bits, said logic including a plurality of transistors, a plurality of NAND gates and a plurality of inverters configured to output delay-matched Booth encoded signals based on said multiplier bits and said complements.

23. The circuit of claim 22, wherein said logic is configured to have a maximum of three gate delays from an input of said circuit to an output of said circuit.

24. The circuit of claim 22, wherein said NAND gates comprise two-input NAND gates.

25. A Booth encoder circuit comprising:
a first subcircuit to receive at least one multiplier bit and complements of at least one multiplier bit, said first subcircuit to provide a signal to first logic circuits, said first logic circuits to output two Booth encoded signals;
a second subcircuit to receive at least one multiplier bit and complements of at least one multiplier bit, said second subcircuit to provide a signal to second logic circuits, said second logic circuits to output one Booth encoded signal;
a third subcircuit to receive at least one multiplier bit and complements of at least one multiplier bit, said third subcircuit to provide a signal to third logic circuits, said third logic circuits to output one Booth encoded signal.
a fourth subcircuit to receive at least one multiplier bit and complements of at least one multiplier bit, said fourth subcircuit to provide a signal to fourth logic circuits; and
a fifth subcircuit to receive at least one multiplier bit and complements of at least one multiplier bit, said fifth subcircuit to provide a signal to said fourth logic circuit, said fourth logic circuit to output one Booth encoded signal.

26. The Booth encoder circuit of claim 25, wherein said circuit is configured to have a maximum of three gate delays from an input of said Booth encoder circuit to an output of said Booth encoder circuit.

27. The Booth encoder circuit of claim 25, wherein said first subcircuit, said second subcircuit, said third subcircuit, said fourth subcircuit and said fifth subcircuit each include a NAND gate and an inverter.

28. The Booth encoder circuit of claim 27, wherein said NAND gates comprises two-input NAND gates.

29. The Booth encoder circuit of claim 25, wherein said Booth encoded signals are substantially delay-matched at an output of said Booth encoder circuit.

30. A partial products generator circuit comprising:
a first multiplexing device having a plurality of first transistors to receive Booth encoded signals and to provide a first partial products output; and
a second multiplexing device having a plurality of second transistors to receive said Booth encoded signals and multiplexed data from said first multiplexing device and to provide a second partial products output.

31. The partial products generator circuit of claim 30, further comprising:
a third multiplexing device having a plurality of third transistors to receive said Booth encoded signals and multiplexed data from said second multiplexing device and to provide a third partial products output.

32. The partial products generator circuit of claim 30, wherein said plurality of first transistors comprise NFET transistors.

33. The partial products generator circuit of claim 30, wherein said first multiplexing device further to receive a signal corresponding to a first bit of a multiplicand and a signal corresponding to a complement of said first bit.

34. The partial products generator circuit of claim 33, wherein said second multiplexing device further to receive a signal corresponding to a second bit of said multiplicand and a signal corresponding to a complement of said second bit.

35. The partial products generator circuit of claim 30, wherein said plurality of first transistors comprise five transistors.

36. The partial products generator circuit of claim 30, wherein said multiplexed data comprises data from a previous bit of a multiplicand.

37. A partial products generator circuit comprising a multiplexing device to receive Booth encoded signals and to provide a first partial product output for a first bit of a multiplicand based at least on multiplexed data from a previous multiplexing device.

38. The partial products generator circuit of claim 37, wherein said previous multiplexing device receives said Booth encoded signals and provides a second partial products output for a second bit of said multiplicand based at least on multiplexed data from another multiplexing device.

39. The partial products generator circuit of claim 38, wherein said multiplexing device further to receive a signal corresponding to said first bit of said multiplicand and a signal corresponding to a complement of said first bit.

40. The partial products generator circuit of claim 39, wherein said previous multiplexing device further to receive a signal corresponding to said second bit of said multiplicand and a signal corresponding to a complement of said second bit.
